(19) United States
(12) Patent Application Publication
(10) Pub. No.: US 2005/0280220 A1
(43) Pub. Date: Dec. 22, 2005

(54) Climbable hand truck

(76) Inventor: Xing Liang Shen, Brooklyn, NY (US)

Correspondence Address: XING LIANG SHEN, 2414 West 1st Street, IF, Brooklyn, NY, 11223-5906, US

(21) Appl. No.: 10/870,253

(22) Filed: Jun. 18, 2004

(51) Int. Cl. B62B 11/00

(52) U.S. Cl. 280/5.28

(57) ABSTRACT

A clamber hand truck is composed of four main parts: arm frame, four wheels, a container and a handle bar. The handle bar controls the attitude of the front wheel and main wheel. When move on horizontal surface, the truck works as normal four-wheel truck. When clambering the stairs, because of the unique structure of the truck that function of rising angle “amplification”, the handle bar only need to turn a little angle, the wheels turn a big angle. Using few simple operations, the hand truck able to clamber on the stairs. During clambering the stairs, the attitude of the weight almost keeps the same as their horizontal level.

### BACKGROUND OF THE INVENTION

The present invention is a hand truck that has ability to clamber on stairs as well as horizontal level movement.

The normal hand trucks have a frame with wheels located at its bottom end and a handle located at its upper end. When moving on the horizontal surface, they request operator manually balances the center gravity of weights to align with on a support line. Some of them have four wheels for horizontal surface movement only. When need to move up and down stairs, they use two wheels and their back bars to slip over the edge of the stairs. The operator needs to pull up or hold down the whole weights, even more force requests because of slip friction. It also may damage the stairs.

### SUMMARY OF THE INVENTION

The new novel features hand truck uses rolling friction in both horizontal and vertical directions. When carrying weights to move on the horizontal surface, because of the special automatic balance structure, it works as normal four wheels hand truck, does not need operator to manually balance the weights, just push forward the handle bar. When carrying weights to move up stairs, the operator needs to push down then pull up the handle bar a little angle, then push forward the handle bar to clamber up stairs. Moving down stairs, most operation is the same as moving up, only pulling force instead of push. During whole operation process, the attitude of the weights almost keeps the same as the horizontal level.

The new hand truck has some main merit as following: The operation of the new hand truck is easy and simple; The structure is reasonable neat and brief, therefor the manufacturing is cheap; The loading capacity can meet any requirement by vary designing. It may widely use to carry heavy weights, especially by its clambering stairs ability.

### BRIEF DESCRIPTION OF THE DRAWING

The figures on the drawing are briefly described as follows:

FIG. 1 is a diagrammatic representation of an assembled hand truck. It comprising by four main parts, there are an arm frame (1); two pair of wheel (2); one container (3) and one hand bar (4).

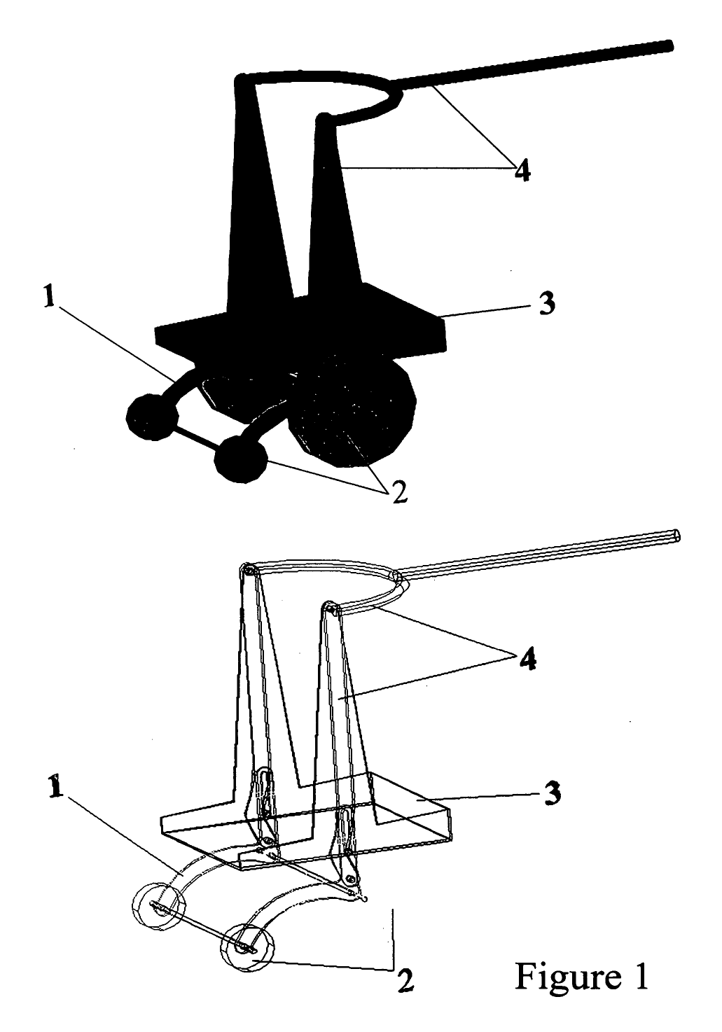

FIG. 2 is a detail diagrammatic representation of an Arm Frame (1). It comprising a pair of arm (11), one front wheel shift (12), one main wheel shift (13), one pair of handle bar pin shift (14), using the pin shift (14) instead of a long handle bar shift is for reduce weight purpose and leaves more space for carrying weights. There has a groove (15) on each arm (11). Those parts may be as one union for rigidity purpose.

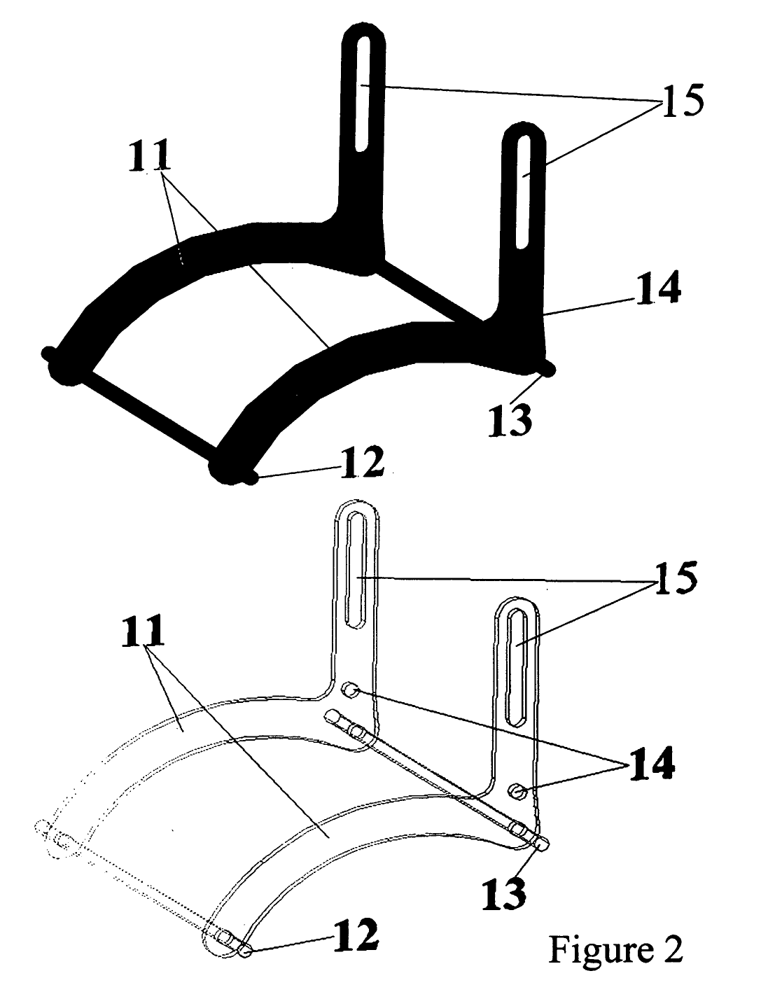

FIG. 3 is a detail diagrammatic representation of the container (3). It is box like or any shape container with two long ear (31). On the top of the ears (31), there are holes (32) to hang on the container (3) into the handle bar (4). On the bottom of the container (3), there are pair of pin shift (33) that will insert into the arm (11)'s groove (15).

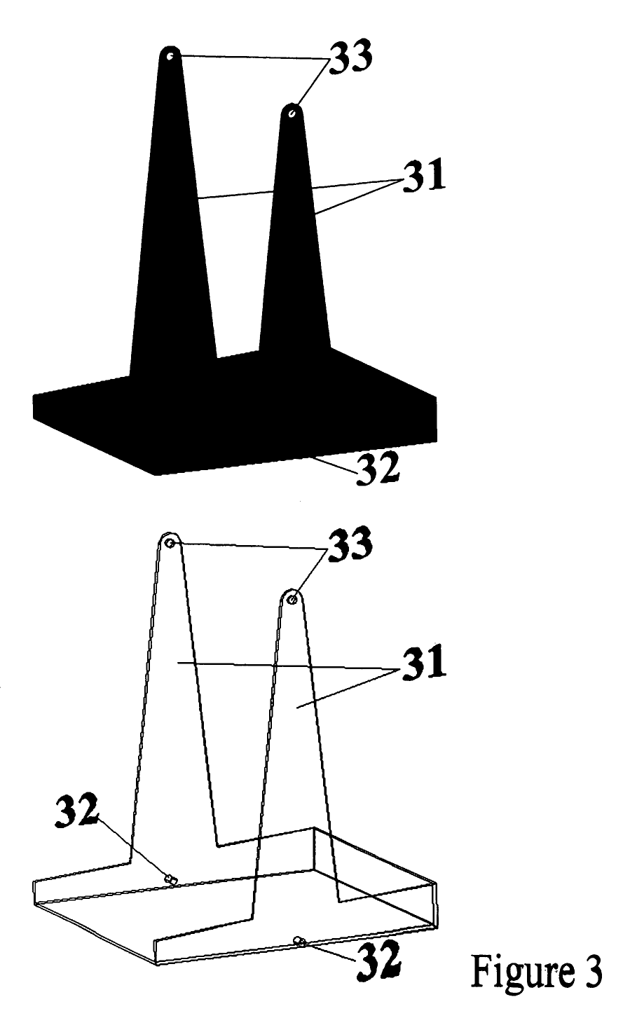

FIG. 4 is a detail diagrammatic representation of the handle bar (4). It is one rigidity union further comprises by a vertical portion (41) and a horizontal portion (42). The horizontal portion (42) has some obliquity to adjust or modify the height of the end point for human operation. On the top of the vertical portion (41), there is a pair of pin shifts (43) for hangs the long ears hole (32) of the container (2). On the bottom of the vertical portion (41), there is a pair of hole (44) to assemble into the handle bar shift (14) of the arms (11).

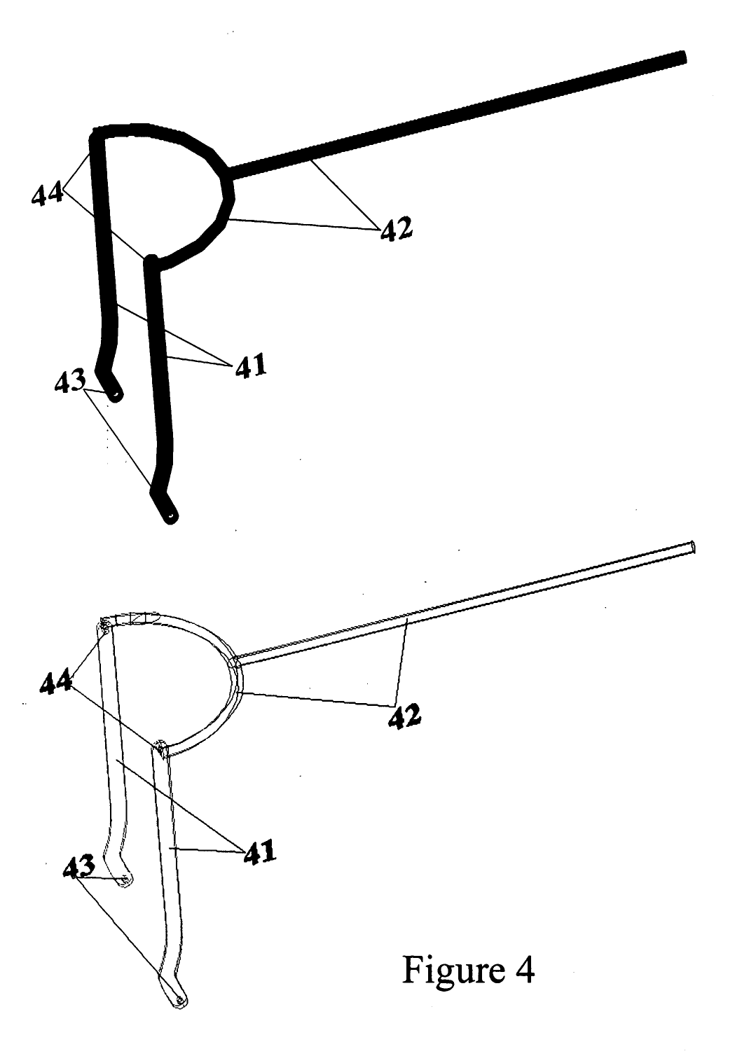

FIG. 5 is a diagrammatic representation of one pair of the Front Wheels (21) and one pair of the Main Wheels (22). There are assemble into the front wheel shift (12) and the main wheel shift (13) respectively.

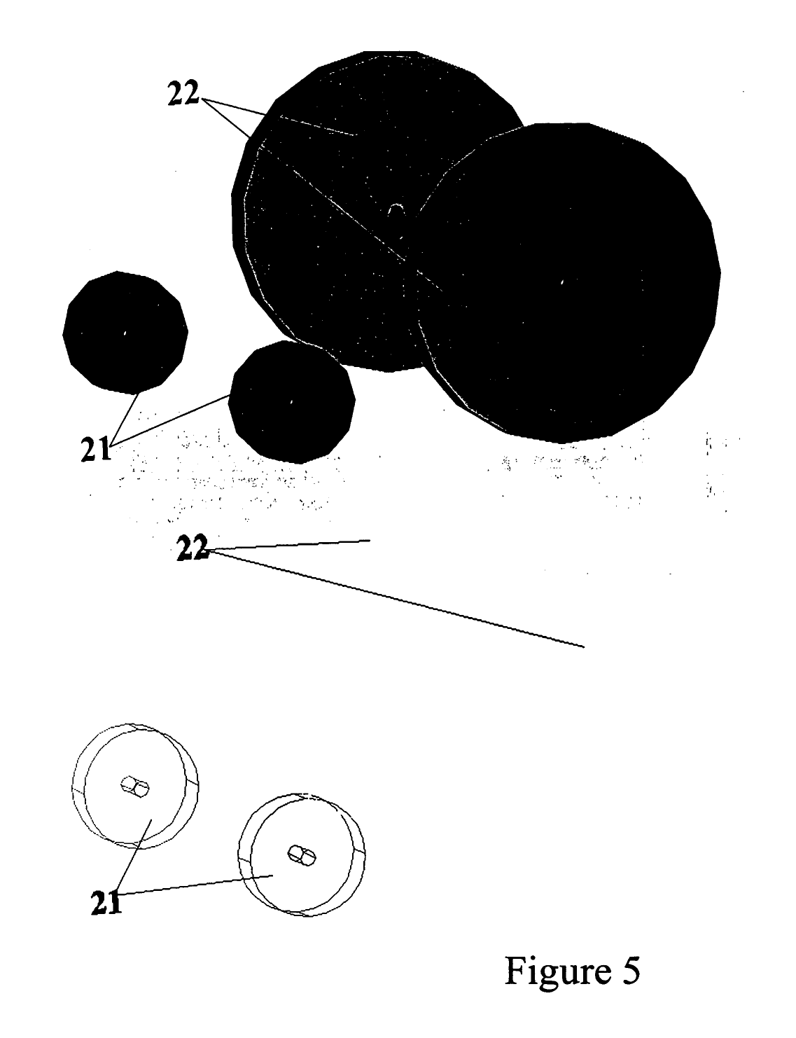

FIGS. 6a,b is a diagrammatic representation of hand truck for explanation of automatic balance structure. For clear display, the wheels that face to reader removed. 6a no bottom pin shift (33); 6b with bottom pin shift (33).

FIGS. 7a,7b is diagrammatic representations of explanation the first stage of how does the hand truck clamber the stairs. For clear view, the wheels that face to reader removed. 7a show the end of first stage of the clambering situation. 7b show the analysis of the force situation.

FIGS. 8a,b is diagrammatic representations of explanation the second stage of how does the hand truck clamber the stairs. For clear view, the wheels that face to reader removed. 8a show the middle of the clambering situation. 8b show the analysis of the force.

### DETAIL DESCRIPTION

1. The Automatic Balance Structure for Still Situation or Horizontal Level Movement.

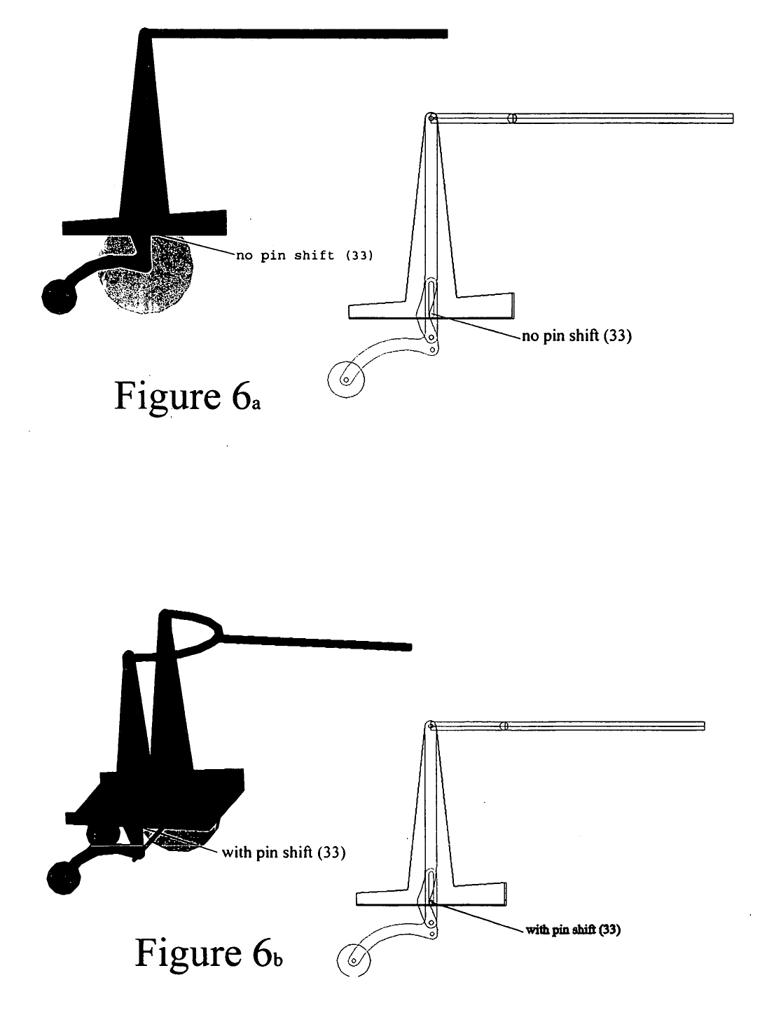

Refer the FIG. 6a, the top of the vertical portion of the handle bar (41) have a pair of pins (43) that used for hang on the container (3). The bottom of the vertical portion of handle bar (41) also has a pair of holes (44) that assemble the handle bar (4) into the pin shift (14) in the arm frame (1). By designing, the center gravity of the weight falls between Front wheel shift (12) and main wheel shift (13). (The center gravity means all weights that including handle bar, container and with its goods.) The bottom pins (33) of the container assemble into the grooves (15) in the arm (11). If there are no those pins insert into the groove, it is obviously this structure is unstable.

Now (refer FIG. 6b). Under above described structure, the handle bar (4) and container (3) has four possible movements:
(a). The handle bar (4) turns around with handle bar pin shift (14);
(b). The bottom pin (33) of container (3) moves up and down in the groove (15);
(c). The container (3) turns around with it's bottom pin (33);
(d). The container (3) turns around top hang on pin shift (43).
   Considering the first (a) situation, if handle bar (3) turns around its handle bar pin shift (14), it will forces container (3) to forward or backward. The bottom pin (33) at the container (3) also have to move forward or backward, then the bottom pin (33) will drive the groove (15) forward or backward that groove (15). The groove (15) is rigidity link with the whole arm frame (1). The result is either the front wheels (21) or main wheels (22) leave the ground. If the operator only pushes the hand truck, so the first situation (a) will not happen because of the center of gravity always keeps as low as possible.

The second (b) situation obviously prohibits because of the fixed length from the hang on pin (43) to the bottom pin (33).

The third (c) situation will force handle bar (3) turns around with bottom pin (33). handle bar (3) has its own turning shift (14), that means handle bar (3) need turns around two different shifts (14) and (33). It is impossible.

The fourth (d) situation also needs to drive the groove (15) forward or backward like situation (a). Therefor the four movements will be prohibited.

As above discussing, the arm Frame (1) keeps its attitude in still situation or moves on the horizontal level condition, like its previous fixed four wheels wagon. The hand truck moves as a rigidity union. It can understood that even so the container (3) hang on the hand bar (4), but it still not swing around with it's hang on pin shift (43).

2. Clamber Stair Situation

When hand truck near the stairs, the operator push down the handle bar (4). Because of the whole hand truck looks like one rigidity union, therefor the whole union turns clockwise around main wheel shift (13). The center gravity of the weight rises. Under this special structure, the Front Wheel (21) rises at the same angle as hand bar (4) does. The operator may not so hard to do it because the long handle bar (4) works as a lever arm. Continuing this process, the center gravity will passes the top point.

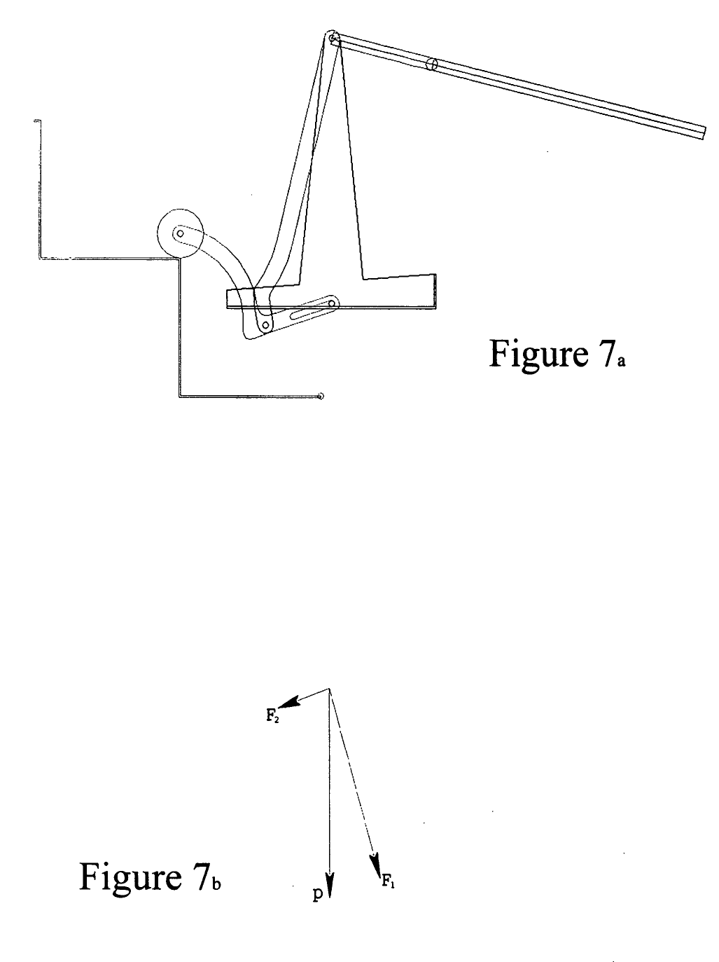

After the center gravity passes the top point, the above “rigidity union” condition broken, the weight itself join to “help” operator. The branch of weight and the branch of human force added together to move the groove (15). The handle bar (4) pushes downs a little angle; the bottom pin (33) in container (3) move almost horizontal level, and the front wheel (21) turns a big angle. The handle bar (3) turns angle “amplified” reflects with the front wheel (21) turning. The operator pushes push down enough, the front wheels (21) will rise to reach the high of second step of the stair. The operator pushes forward the hand truck so the front wheels (21) now contact with the second step of the stairs. Refer FIG. 7a. The force analysis shows in the FIG. 7b. P is the total force that adds to the groove (15). F1 is a portion force of perpendicular to the groove (15). F2 is a portion force of parallel to the groove (15). If the arm frame (1) with its four wheels so heavy, the operator may need force to push down. So weight of arm frame (1) with its four-wheel (2) should be as light as possible for reduce the turns force.

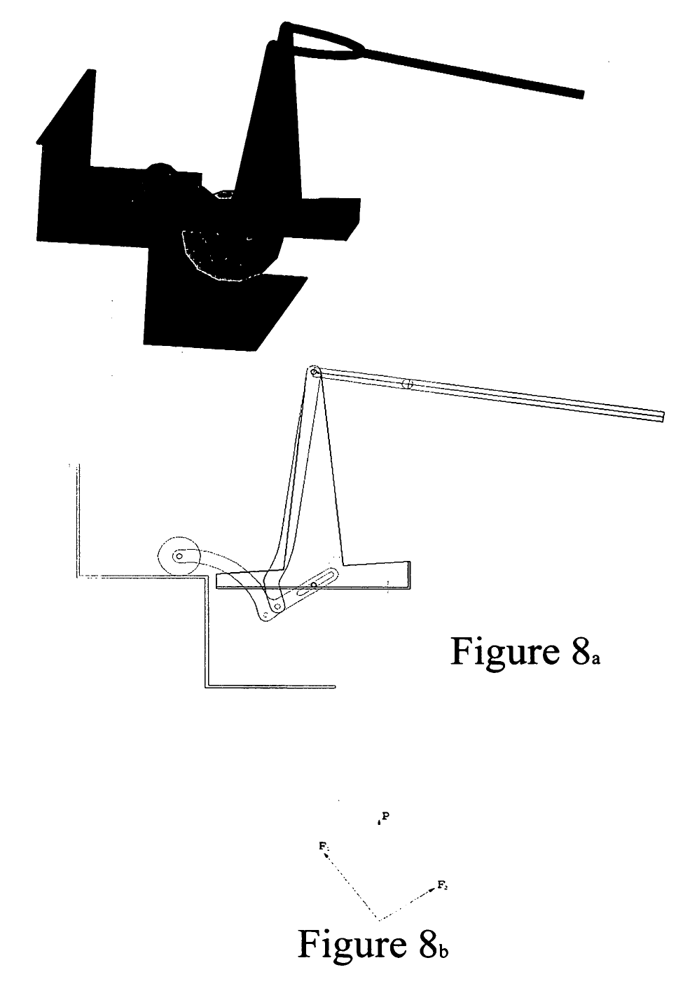

In the second stage, the operator start rises the handle bar (4). When handle bar (4) rise, the container (3) try to keep on vertical attitude because its weight. Its bottom pin (33) moves forward and pushes the groove (15) up. The main wheels (22) rises up. This process like reverse of the push down process, only the turning points change from main wheel shift (13) to front wheel shift (12). The middle process shows as FIG. 8a. The force analysis shows in FIG. 8b. As the hand bar (4) rises to horizontal level, the Main Wheels (22) follows to rise up to the normal horizontal level. Operator continues pushes the hand truck forward until the Main Wheels (22) contact the second step and also the center gravity of weight passes top point and to fall into the stable location. One step of stairs clambered completely. Repeat those process may clamber the rest of stairs.

3. Few Design Relationship

We find:
Riser=7˜9″ . . . the Riser is a length of one vertical step.
Straight=10˜12″ . . . the Straight is a length of one horizontal step.
a). The formula for minimum requirement length of the hand truck can clamber on the stairs is
   S=R+2r<Straight (1)
   Here “S” is distance between front wheel shift and main wheel shift. “R” is the main wheel radius. “r” is the front wheel radius. The diameter of the front wheel will more affect to the minimum length of the Straight of the stairs. So choice small size wheel for the front wheel.
b). The formula of the maximum rise of the hand truck can clamber on the stair is
   R+R*Cotan [ Sin⁻ⁱ(R/S)] (2)
   Here “R”, “r” and “S” are the same definition. “S” is determined by first condition. So choice as big as possible for the main wheel.
c). The relationship of location of the main wheel shift (13) and the handle bar pin shift (14). The handle bar pin shift (14) should located between Front wheel shift (12) and Main Wheel Shift (13). The pin shift (14) may choice to close the Main Wheel Shift (13) for easy operation. More close the middle point; the hand truck will has more stable in horizontal movement, but harder in stair clamber situation. Verse vise.
d). Some variation
   The distance “S” between Front wheel shift (12) and main wheel shift (13) may has some variation. The formula (1) may change as following:
   S=R+2r<N*Straight
   Here “N” is integer number. The result of the hand truck may have “long leg”. The front wheel (21) already reach several steps, the main wheel still on the ground. Figure X shows this situation.

1. A hand truck comprising:
A hand truck arm frame, said arm frame composed a pair of arm, one front wheel shift, one main wheel shift, and a pair of handle bar pin shift. Those parts may join together as one union for rigidity purpose. The said hand bar pin shift located between said front wheel shift and main wheel shift. In the said pair of the arm, there is a groove above the said handle bar pin shift.

2. A hand truck comprising:
One pair of the front wheel, one pair of the main wheel, they assemble into the said front wheel shift and main wheel shift in the said arm frame respectively.

3. A hand truck comprising:
One handle bar, the said handle bar has a vertical portion and a horizontal portion, the said vertical portion have left and right bars, at the top of said each bar has a pin shift for hang the container; at the bottom of said each bar has a hole that assemble into the handle bar pin shift of said arm frame in claim 1, the one end of said horizontal portion that connected with said vertical portion have two side bar that rigidity connect with two side said vertical bar, said two side horizontal bars may meet on a intermediate point so that the rest of said horizontal portion become one bar until to the other end, the whole said handle bar may be one rigidity union.

4. The hand truck comprising:
a container that is box like or any shape that can load weights. In the side of said container, there are two ear like bar at each side, at the top of said ear bar, there is a hole to further hang on the said handle bar pin shift in claim 3, the bottom of said container has a pair of pin at each side, the said bottom pin further inserted into said arm frame groove in claim 1.

5. The assembled a hand truck from said parts of claim 1,2,3 and 4, said handle bar works as the power delivery and control the attitude of said front wheel and said main wheel, said handle bar moves little angle will case said front wheel or main wheel rise a big angle, said handle bar movement “amplified” and affect front wheel and main wheel movement.

6. The assembled a hand truck from said parts of claim 1,2,3 and 4, move on the horizontal surface, have a stable condition, substable condition, if operator only push the handle truck forward.
